(19) United States
(12) Patent Application Publication
(10) Pub. No.: US 2004/0195955 A1
(43) Pub. Date: Oct. 7, 2004

(54) Gas discharge lamp

(76) Inventors: Gil Teva, Jerusalem (IL); Uriel Ronen, Kfar-Saba (IL)

Correspondence Address: William H Dippert, Reed Smith, 29th Floor, 599 Lexington Avenue, New York, NY, 10022-7650, US

(21) Appl. No.: 10/483,694

(22) PCT Filed: Jul. 14, 2002
(86) PCT No.: PCT/IL02/00566

Related U.S. Application Data
(60) Provisional application No. 60/304,941, filed on Jul. 13, 2001.

(51) Int. Cl. H01J 1/62; H01J 61/10

(52) U.S. Cl. 313/493

(57) ABSTRACT

A gas discharge apparatus (100) with a cylindrical axis, comprising: at least one pair of electrodes (106, 110); a cylindrical outer tube (114), surrounding the axis; a cylindrical inner tube (102) surrounding the axis; and a gas contained between said inner tube (102) and said outer tube (104), of suitable composition and pressure to create a gas discharge current when sufficient voltage is applied to said electrodes (106, 110), wherein no discharge is present inside the inner tube (102) during operation.

### RELATED APPLICATIONS

The present application claims the benefit under 119(e) of U.S. provisional application No. 60/304,941 filed Jul. 13, 2001, the disclosure of which is incorporated herein by reference.

### FIELD OF THE INVENTION

The present invention is in the field of gas discharge lamps, such as fluorescent lights and sodium vapor lights, and other gas discharge devices.

### BACKGROUND OF THE INVENTION

Due to thermal and magnetic effects, gas discharges tend to shrink down to a characteristic width comparable to the distance that an electron diffuses before it recombines, unless the discharge is already confined to a narrower width. This characteristic width depends on parameters such as the electric field, and for typical gas discharge lamps it is on the order of a centimeter. It is often desirable to have a light source that is uniformly spread out over a width greater than this. The characteristic width may be increased by decreasing the electric field, but this may also decrease the light intensity. Or a narrow discharge may be enclosed in a phosphor-coated glass tube of substantially greater diameter than the discharge, but this also results in lower light intensity at the surface of the tube.

Several designs are known for fluorescent lights and other types of gas discharges in which the glow is spread out over a greater width than would be possible in a single straight tube, without decreasing the light output power per area. Some of these devices simply involve bending a straight tube of uniform diameter into some curved shape, for example U.S. Pat. No. 4,862,035, or otherwise creating a curved channel of uniform cross-section, for example U.S. Pat. No. 4,833,574. These devices have the disadvantage that the tubes are complicated in shape and expensive to manufacture. In other designs, gas discharges which fold back on themselves, sometimes more than once, are created by using open-ended straight cylindrical glass tubes which are placed inside larger sealed straight cylindrical glass tubes. Although these devices are less expensive to manufacture than devices using bent tubes, they have other disadvantages, which will be described below. Some of these designs are axisymmetric, or nearly so, while others are not axisymmetric.

The non-axisymmetric designs include those described in U.S. Pat. No. 4,208,618, assigned to Westinghouse, and Japanese patent publication JP55128245. In the Westinghouse device, three or four smaller diameter tubes, open at top, are placed side by side inside a larger glass tube with a cap on top. Electrodes at the bottom of each of the smaller tubes allow a discharge current to flow up one or two of the tubes, turn around under the cap, and flow down into one or two of the other tubes, depending on the sign of the voltage applied to the electrode at the bottom of each tube. In JP55128245, there is an inner tube in the center of an outer tube, with an electrode at the bottom of the inner tube, and two electrodes at the bottom of the outer tube, just outside the inner tube, one to each side of the inner tube. AC voltages on the outer electrodes, relative to the inner electrode, are 90 degrees out of phase with each other. A discharge from the inner electrode goes alternately to each of the outer electrodes.

Axisymmetric designs (or more precisely, designs whose non-axisymmetric components have a high order azimuthal symmetry, for example m=6) include those described in Japanese patent publications JP61176046 and JP62229751, both assigned to Toshiba. In both these designs, there are three concentric glass tubes. Electrons flow out of (or ions flow into) a cathode at the top of the inner tube, down the inner tube, through one or more openings near the bottom of the inner tube and up between the inner and intermediate tubes, through the top of the intermediate tube and down between the intermediate and outer tubes to several anodes spaced around the bottom of the outer tube. In JP61176046, to prevent the discharge from coalescing and all flowing into one anode, the openings near the bottom of the inner tube consist of small holes, one for each anode. In JP62229751, coalescence of the discharge is avoided by only applying voltage to one anode at a time, in a sequence of pulses, so that at any given time the discharge is only connected to one anode. Another axisymmetric design, US application. 2002/0017866A1, has several concentric tubes, with a baffle in the center of all but the outermost tube, and two electrodes, one at each end of the innermost tube. Current flows from one of the electrodes, down the innermost tube to the baffle, where it goes through an opening to the space between the innermost tube and the next tube further out. It then flows up that tube to the top, down the next tube to the baffle, and so on, until it reaches the outermost tube, which has no baffle in the center, and flows all the way through it to the other end The current then flows back and forth as it goes from one tube to the next tube further in, on that side of the baffle, until it reaches the innermost tube and flows through the innermost tube to the other electrode.

The device disclosed in U.S. Pat. No. 4,631,452 has an even number of pairs of electrodes, for example 6 pairs of electrodes, distributed uniformly around the inside of a single tube, with one electrode of each pair at each end of the tube, and a discharge associated with each pair. Depending on how voltage is applied to the electrodes, this device can operate either in an axisymmetric mode, with current flowing in the same direction in each discharge, or in a mode with m=3 azimuthal symmetry, with current flowing oppositely in adjacent discharges. When current flows the same way in all the discharges, then they coalesce and form a single discharge in the center, but remain separate at their ends, near the electrodes. When the current flows in opposite directions in adjacent discharges, the discharges repel each other, and remain separate. The discharge does not flow between adjacent electrodes at the same in this case, because the external circuit connecting adjacent electrodes, through the power supply, has a high impedance.

These designs have several disadvantages. Even if the electrodes (and the holes in JP61176046) are made alike, and positioned uniformly, within manufacturing tolerances, slight errors in manufacture, or asymmetries that develop during operation, will tend to make more current flow to some electrodes than to others. Even slight asymmetries in current density may become greatly magnified, due to thermal and magnetic instabilities in the discharge. This may lead to very non-uniform light intensity and non-uniform heating. Devices which sequentially have current flowing to only one electrode at a time may avoid the problem of asymmetry in light power and heating, but they do not make use of most of the volume of the tube at any given time, and have lower average output power than they could have. And all devices using one or more inner tubes inside an outer tube have a problem transporting heat from the inner tube to the outer surface. Even if the device does not overheat, large differences in temperature between the inner and outer tube will mean significant differences in background gas density (for example argon), and in the density of any volatile minority species (for example mercury vapor or sodium vapor). Similarly, an axisymmetric current flowing from an electrode in an inner tube to several electrodes on the outside will have higher current density and probably higher electric field in the inner tube than on the outside. Generally, the characteristics of gas discharges are sensitive to the background gas density, minority species density, and electric field, and there are optimal values for these quantities, and optimal relationships between them. If any of these quantities vary significantly within the discharge, then conditions will not be optimal everywhere, and the discharge will have lower light output per volume, or lower efficiency, than an optimized single tube discharge.

### SUMMARY OF INVENTION

An aspect of some embodiments of the invention concerns a gas discharge lamp with current flowing largely in the axial direction, and with the discharge contained in a region between an inner tube which surrounds the axis, and an outer tube. Optionally, the inner tube is open to the outside environment. This arrangement allows multiple discharges to be arranged around the tube, while avoiding some of the disadvantages of the prior art. For example, because there is no discharge located within the inner tube, there is better heat transport than in prior art devices which have part of the discharge in such an inner tube on the axis. In fact, in embodiments of the invention where the inner tube is connected to the outside, the heat transport may be even better than in a conventional gas discharge lamp with a single straight tube, because air can convect heat away from the inside as well as from the outside.

Another advantage of these embodiments of the invention is that multiple discharges cannot coalesce into a single discharge on the axis, since the discharge is excluded from the region around the axis. Any coalescence of discharges would have to occur off to the side, which may be less energetically favorable than coalescence of discharges on the axis. In fact, multiple discharges may coalesce to form a uniform discharge distributed around the tube on all sides, which would be an improvement over multiple separate discharges since the light emission and heating would be more uniform. However, in some embodiments, the discharges remain separate along their length.

In some embodiments of the invention, the tube is partially divided on the inside by an intermediate tube, into an inner annulus and an outer annulus. Current flows from electrodes distributed around the bottom of the inner annulus, up and around the intermediate tube, and down to another ring of electrodes distributed around the bottom of the outer annulus. (The current could also flow in the opposite direction, of course.) This is an improvement over the prior art in which current flows between a single electrode on axis, up an inner tube, and down to a ring of electrodes on the outside, since in these embodiments of the present invention, the cross-sectional area does not differ so much (or may not differ at all) between the inner and outer annulus, so the current density does not differ so much. This avoids the problem of a large difference in temperature (hence in gas density and minority species density) and in current density, between the inner and outer part of the discharge, which occurs in the prior art. Another advantage of these embodiments of the invention over the prior art where the discharge flows on axis, is that the discharge tube is cooled more effectively, since the inner surface of the inner tube is exposed to the outside air, and can be convectively cooled.

In some embodiments of the invention, some or all of the different tubes (inner and outer tubes forming a toroidal tube, and an intermediate tube if there is one) fit together with very close tolerances, to form a discharge region that is very narrow radially. This is potentially advantageous because multiple discharges confined to a narrow region radially may spread out azimuthally, resulting in more uniform light emission and heating, even if the multiple discharges do not merge together. To keep closely fitting adjacent tubes from touching each other over much of their surface, if they get slightly out of alignment, there are optionally small bumps on the adjacent surfaces of one or both tubes. Optionally the bumps are small enough, in both axial and azimuthal extent, so that they do not interfere, or interfere very little, with the behavior of the discharge.

In some embodiments of the invention, there are vertical baffles arranged azimuthally around the tube, which prevent multiple discharges from coalescing. Optionally, the baffles are air tight, and seal off the different discharges from each other completely. Alternatively, the baffles are not air tight, but have small enough passages circumventing them that it is not energetically favorable for the different discharges to coalesce.

An aspect of some embodiments of the invention concerns a gas discharge tube in which an inner tube keeps the discharge away from the axis, and in which different discharges, or different parts of the same discharge (for example, different turns of a helical discharge) are prevented from coalescing by means of ripples in one of the tubes, which bring the two tubes into contact, or at least much closer together, in the regions between two discharges, or between two parts of the same discharge. These ripples extend over much of the length of the tube, unlike the bumps discussed above, which are very small in all directions. Optionally, the ripples are on the inner tube, and the outer tube is smooth. Alternatively or additionally, the ripples are on the outer tube. Optionally, the discharge currents flow in the axial direction, and the ripples are arranged azimuthally (that is to say, the displacement of the tube from a circular cylinder is a function only of the azimuthal coordinate θ). Alternatively, the discharge is helical, either a single helical discharge or multiply interwound helical discharges, and the ripples are helical. Optionally, there are electrodes of one polarity at one end of the tube, and the currents flow between those electrodes and electrodes of the opposite polarity at the other end of the tube. Alternatively, all the electrodes are at one end, and the current in each discharge flows from an electrode down one ripple, through an opening into an adjacent ripple, and back up that ripple to an electrode of opposite polarity. Alternatively, the discharge continues to go up and down the tube through adjacent ripples, and the whole discharge region may be covered by a single discharge going up and down.

The embodiments of the invention with ripples in the envelope have some resemblance to prior art devices in which one or more discharges travel through convoluted tubes or channels. However, the rippled glass tubes are less expensive to manufacture. This is especially true if regions inside the ripples are not completely sealed off from each other, since the dimensions of the ripples will not be very critical in that case.

There is thus provided, in accordance with an exemplary embodiment of the invention, a gas discharge apparatus with a cylindrical axis, comprising:

at least one pair of electrodes;

a cylindrical outer tube, surrounding the axis;

a cylindrical inner tube surrounding the axis; and

a gas contained between said inner tube and said outer tube, of suitable composition and pressure to create a gas discharge current when sufficient voltage is applied to said electrodes,

wherein no discharge is present inside the inner tube during operation.

In an embodiment of the invention discharge current flows substantially parallel to the axis along the length of the tubes.

Optionally, the inside of the inner tube is open to the outside environment. Optionally, the inside of the inner tube is open to the outside environment at both ends thereof.

In an embodiment of the invention, the apparatus includes:

a first end seal sealing between the inner and outer tubes at one end; and

a second end seal sealing between the inner and outer tubes at the other end,

wherein one electrode of each pair of electrodes is located adjacent to the first end, and the other electrode of each pair of electrodes is located adjacent to the second end.

In an alternative embodiment of the invention, the apparatus includes:

a first end seal sealing between the inner and outer tubes at one end;

an intermediate tube situated between the outer tube and the inner tube;

a second seal, sealing between the inner and outers tube at the other end, but not sealing the intermediate tube;

wherein one electrode of each pair of electrodes is located adjacent to the first end plate between the inner tube and the intermediate tube, and the other electrode of each pair of electrodes is located adjacent to the first end plate between the intermediate tube and the outer tube.

Optionally, the apparatus includes bumps on a surface of a first one of the tubes, which surface faces a second one of the tubes, said bumps providing a fixed spacing between the tubes. Optionally, the bumps are sufficiently small and far apart that they do not significantly reduce the discharge current.

In an embodiment of the invention, the apparatus includes at least one barrier located between two electrodes of different pairs, which barrier reduces the discharge current flowing between said electrodes of different pairs. Optionally, the barriers extend parallel to the discharge for a majority of the length of the discharge. Optionally, the barriers extend radially from one or both of the inner and outer tubes. Optionally, the barriers extend from one of the tubes and contact an adjacent tube. Optionally, the barriers extend only part of the distance between adjacent tubes. Optionally, the discharge is formed with a current in a first axial direction between two barriers and returns via a space between two adjacent baffles.

In an embodiment of the invention, the inner and outer cylindrical tubes have a circular cross-section. Alternatively or additionally, at least one of the tubes does not have a circular cross-section.

Optionally, the at least one tube having not having a circular cross section has a fluted cross-section. Optionally, the flutes contact at least one adjoining tube at the extremities of the flutes. Optionally, the contacts comprise a seal. Alternatively, the flutes do not contact the adjoining tube at the extremities. Optionally, the flutes are formed in the inner tube. Alternatively or additionally, the flutes are formed in the outer tube. Alternatively or additionally, the flutes are formed in a tube intermediate the inner and outer tubes. Optionally, the discharge is formed with a current in a first axial direction between two flutes and returns via a space between two adjacent flutes.

Optionally, the apparatus includes metallic elements placed along a desired path of the discharge.

Optionally, the apparatus includes metallic elements placed outside the envelope of the discharge along and adjacent a desired path of the discharge.

In an embodiment of the invention, one or more surfaces of one or more tubes is coated with a phosphor that converts radiation produced by the discharge into light having a desired wavelength or wavelengths.

In an embodiment of the invention, the apparatus includes electronics for energizing said discharge, situated axially of the inner tube.

In an embodiment of the invention, the apparatus includes a screw socket at one end thereof supplying electrical power to said electronics.

### BRIEF DESCRIPTION OF THE DRAWINGS

Exemplary embodiments of the invention are described in the following section with reference to the drawings. The drawings are generally not to scale. The same or similar parts in different drawings may be designated with the same number.

FIG. 1A is a side cross-sectional view, FIG. 1B is an axial view, and FIG. 1C is a perspective view, of a gas discharge tube, according to an exemplary embodiment of the invention;

FIG. 2A is a side cross-sectional view, and FIG. 2B is an axial view, of a gas discharge tube according to another exemplary embodiment of the invention;

FIG. 3A is a side cross-sectional view, and FIG. 3B is an axial view, of a gas discharge tube according to an exemplary embodiment of the invention;

FIG. 4 is a perspective view of a gas discharge tube, according to another exemplary embodiment of the invention;

FIG. 5A and FIG. 5B are perspective views of gas discharge tubes, according to two other exemplary embodiments of the invention;

FIG. 6 is a perspective view of a gas discharge tube, according to another exemplary embodiment of the invention;

FIG. 7 is a schematic drawing of a gas discharge tube, showing the path of the discharge current through openings made by the ripples, according to another exemplary embodiment of the invention; and

FIG. 8 is a perspective view of a segmented capacitor connected to a gas discharge tube, according to an exemplary embodiment of the invention.

### DETAILED DESCRIPTION OF THE INVENTION

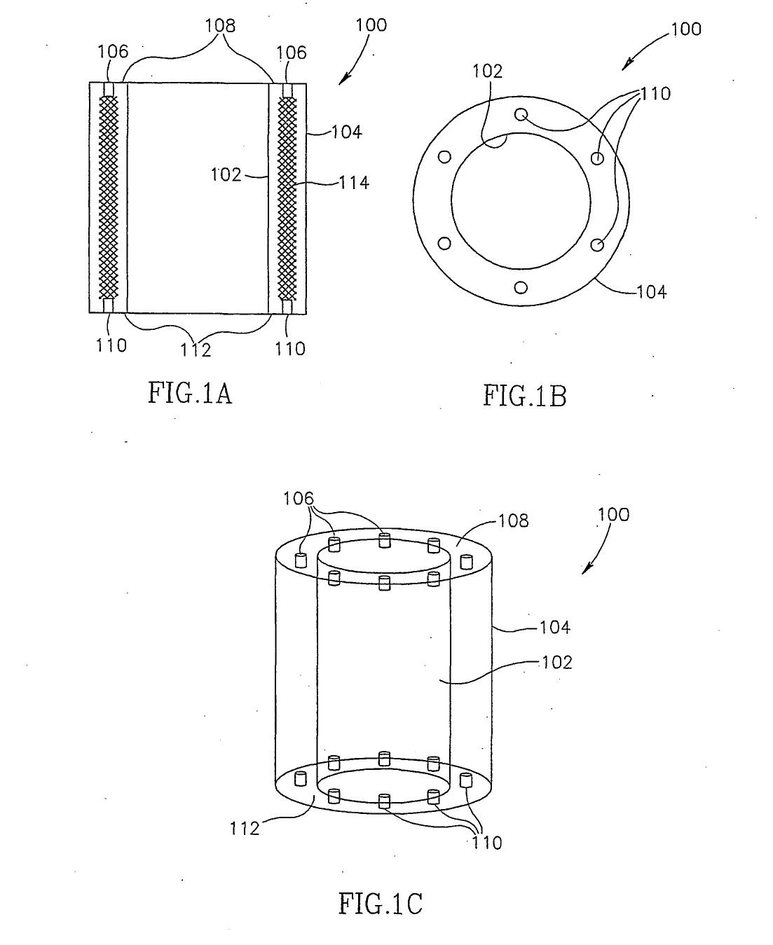

FIGS. 1A, 1B, and 1C show respectively a side cross-sectional view, an axial view, and a perspective view of a gas discharge tube 100 in accordance with an embodiment of the invention. Tube 100 is toroidal in topology, with an inner tube 102 whose interior is optionally open to the outside, and an outer tube 104. The space between the inner and outer tube is sealed, and filled with a gas with a composition and pressure suitable for a gas discharge lamp, for example argon at a pressure on the order of 1 Torr, and optionally a minority species such as mercury vapor or sodium vapor. Several electrodes 106 (six are shown in FIGS. 1B and 1C) are spaced around the top 108 of tube 100 on the inside, and an equal number of electrodes 110 are spaced around the bottom 112 of tube 100 on the inside, with each bottom electrode directly under one of the top electrodes. (The words “top”, “bottom” and “under” are used here to refer to the parts of the tube as it is shown in FIGS. 1A and 1C. Similar language is used in describing some of the other drawings. In actual use, the tube may of course be oriented in any direction.) When sufficient voltage is applied between any one of the top electrodes and the corresponding bottom electrode, a discharge 114 (shown only in FIG. 1A) is formed between those electrodes. If such a voltage is applied to all of the pairs of electrodes, or to any plurality of the pairs of electrodes, then (if there is an appropriate impedance connecting each electrode to the power supply) multiple discharges are formed. Depending on the number and spacing of the electrodes, the inner and outer diameter and length of the tube, and other characteristics (for example, the voltage, the impedance to the power supply, the relative polarity or phase of different electrode pairs, and the pressure and composition of the gas filling the tube), the discharges may remain separate, or they may merge to form one continuous discharge all around the tube, or they may merge to form one discharge on only one side of the tube. The latter result may be undesirable since it may lead to uneven heating and light output, and discharge characteristics which vary along the length of the tube and around the tube, and are not optimal in some locations, resulting in lower efficiency and less pleasant light. Some of the other embodiments of the invention described below include various means to prevent such merging of discharges. On the other hand, a merged discharge which is distributed uniformly around the tube may be desirable, since it may lead to more even heating and hence more efficient cooling, and more light output.

For clarity, FIG. 1 and the other drawings have not been drawn to scale. Optionally, the tubes are considerably longer than shown in the drawings, relative to their diameter. (However, if the tube is too long relative to its diameter, the multiple discharges may be more likely to merge on one side of the tube.) For example, in an embodiment of the invention, outer tube 104 is 6 cm in diameter, inner tube 102 is 4 cm in diameter, and the tubes are 60 cm long. In this exemplary embodiment of the invention, there are 15 pairs of electrodes, spaced approximately 1 cm apart, halfway between the inner and outer tubes, and each carrying a current of 0.2 amperes, for a total current of 3 amperes, and the voltage is 60 volts, so the electric power is 180 watts. The tube is filled with 10 millibars of argon, and a small amount of mercury to produce mercury vapor, and the inside of the outer tube is coated with a phosphor. It is expected that a fluorescent light of this design will have an output of 10,800 lumens, and a lifetime of 30,000 hours. Other dimensions are also possible, and it may be advantageous to have the inner tube diameter closer to the outer tube diameter than this.

Optionally, the distance between the inner and outer tubes is made as small as practical, with distances of 0.4, 0.3 or even 0.1 or a fraction of a millimeter being desirable. While it is believed that a smaller spacing will result in better operation, too low a spacing can result in an insufficient discharge volume to provide adequate light. Larger spacing, especially with short tubes, is also possible.

Optionally, the electrodes, in tube 100 or in other embodiments of the invention, are heated, so that they emit electrons at lower electric field than if they were unheated. This heating reduces the sheath voltage adjacent to an electrode that is acting as a cathode, and reduces the total discharge voltage required for a given discharge current. Optionally, each electrode, or one of the pair of electrodes for each discharge, has its own ballast, electrically connected to the power supply in series with the electrode. The ballast may comprise a resistor, capacitor, or inductor. Relatively small capacitors and/or coils may be used when the voltage has high enough frequency.

Any suitable electrode shape as known in the art may be used, such as simple sharp or blunt electrodes, resistive coils or indirectly heated conducting sheaths, which are heated by an internal heater.

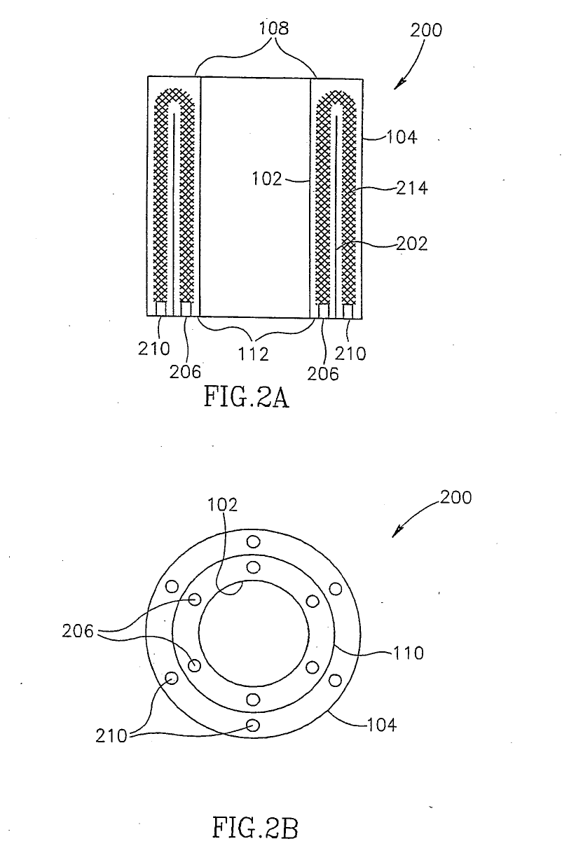

FIG. 2A is a side cross-sectional view, analogous to FIG. 1A, of a gas discharge tube 200 according to another exemplary embodiment of the invention, and FIG. 2B is an axial view of tube 200, analogous to FIG. 1B. Tube 200, like tube 100, is toroidal in topology, with an inner tube 102 open to the outside, and a sealed outer tube 104 with a top 108 and a bottom 112. In addition, tube 200 has an intermediate tube 202, attached to the bottom of tube 200, but not extending all the way to the top of tube 200. Six inner electrodes 206 (optionally a greater or smaller number is used) are distributed around the bottom inside tube 200, between inner tube 102 and intermediate tube 202. An equal number of outer electrodes 210 are distributed around the bottom inside tube 200, between the intermediate tube and the outer tube, with each outer electrode located across from a corresponding inner electrode. When voltage is applied between each corresponding pair of electrodes, a discharge 214 forms (shown only in FIG. 2A), which goes from the inner electrode, up over the top of the intermediate tube, and down to the outer electrode. This configuration may produce more emitted light per area than tube 100 shown in FIG. 1, since light comes from both the inner and outer part of the discharge. The discharge in FIG. 1 may be limited to the same radial thickness as just the inner part or just the outer part of the discharge in FIG. 2, because of the tendency of discharges to contract to a characteristic width. Furthermore, the fact that the discharge in FIG. 1 is less confined in the radial direction than the discharge in FIG. 2 may mean that multiple discharges in FIG. 1 are more likely to merge into a single discharge on one side of the tube.

Some of the prior art discharge tubes described above also have discharges which are “folded over” like that in FIG. 2. But in those prior art devices the inner part of the discharge is on the axis of the tube, leading to the disadvantages discussed above, including problems with heat transport, and very different characteristics for the inner and outer parts of the discharge. In FIG. 2, the inner and outer parts of the discharge may have similar current density, especially if the intermediate tube is closer in diameter to the outer tube than to the inner tube, so that the cross-sectional area between the intermediate tube and outer tube is approximately equal to the cross-sectional area between the intermediate tube and the inner tube. Also, in FIG. 2, both the inner and outer parts of the discharge are adjacent to glass surfaces which are directly in contact with the outside air, so cooling should not be so much of a problem. Convective cooling of the inside of the inner tube may be especially efficient if the tube is oriented vertically, and if an electrical fixture (not shown in the drawings) that one end of the tube is connected has a hole going through the center, so that air can flow freely through the center of the fixture and through the inner tube of the discharge tube.

For some embodiments of the invention, it may be desirable to have a discharge tube comprising two tubes with very little clearance between them, for example the inner and outer tube in FIG. 1, or the intermediate tube and one of the other tubes in FIG. 2. Such a design might prevent adjacent multiple discharges from merging, for example, even if there are many narrow discharges with little distance between adjacent discharges. In these cases, due to imperfect manufacturing of parts, or slight wear or damage of parts during use, the two tubes may be misaligned, and touch each other over a significant area.

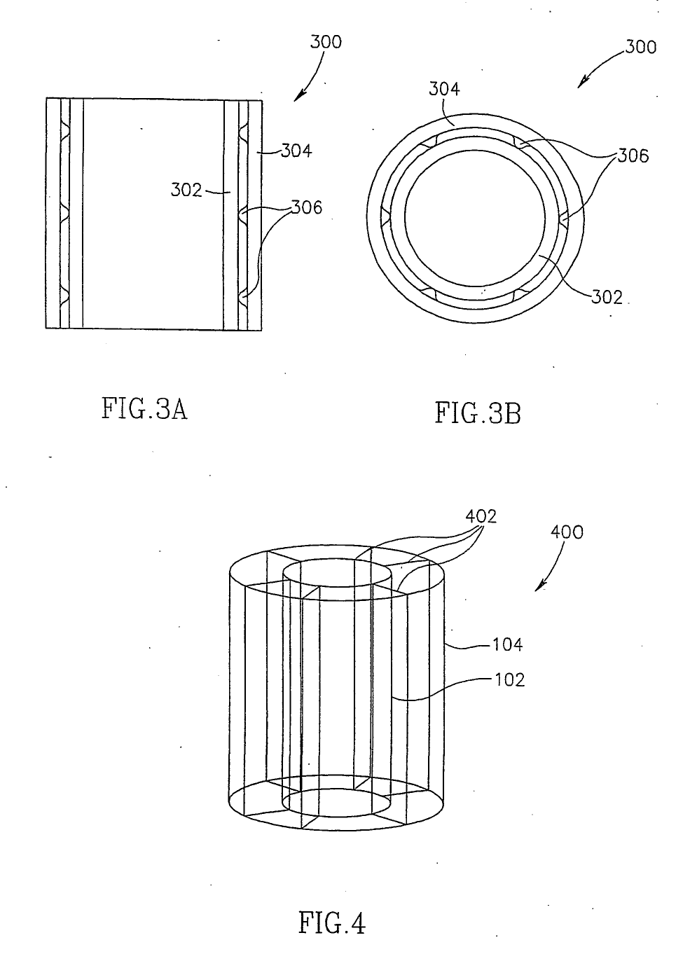

FIG. 3A, a side cross-sectional view of a discharge tube 300, which comprises two concentric tubes 302 and 304, shows a way to prevent this. Small bumps 306 on one of the tubes (they are shown on the outer tube in FIG. 3A) contact the other tube, but only over a small area, keeping the tubes at the proper separation distance over most of their surface area. The bumps in FIG. 3A do not represent belts going all the way around azimuthally, but are very limited in width azimuthally, as they are limited in vertical extent. This may be seen in FIG. 3B, which shows an axial cross-section of the same discharge tube. The small regions of contact at the bumps do not significantly affect the discharge, which can easily go around a bump which is positioned in the way of the discharge. If the discharge comprises multiple discharges which are not supposed to merge, then the bumps optionally are positioned so that they are between discharges, and do not interfere with the discharges at all. Although the bumps can be located on both the inner surface of the outer tube and on the outer surface of the inner tube, putting the bumps on only one tube makes it possible to easily insert the inner tube into the outer tube. If there were bumps on both tubes, and they are not aligned properly during assembly, then the bumps might touch each other and make it difficult to insert the inner tube into the outer tube. Optionally the bumps are only at the ends of the tubes. If one of the tubes has bumps only at one end, and the other tube has bumps only at the other end, then the tubes can be assembled without the bumps rubbing against either tube until the tubes are nearly in their final position.

It may be desirable in some discharge tubes to use barriers of some kind to prevent adjacent multiple discharges from merging. FIG. 4 shows a discharge tube 400, with an open inner tube 102 and a sealed outer tube 104, similar to FIG. 1. Six electrodes 106 are placed around the top and six electrodes 110 are placed around the bottom, as described for FIG. 1. Six vertical baffles 402 extend from the inner tube to the outer tube, separating the six discharges, and preventing them from merging. Optionally, the baffles completely seal the discharges off from each other. Alternatively, the baffles are not air tight, but impede the discharges sufficiently to prevent them from merging. Such loosely fitting baffles may be less expensive to manufacture than baffles that would be air tight, and might work just as well.

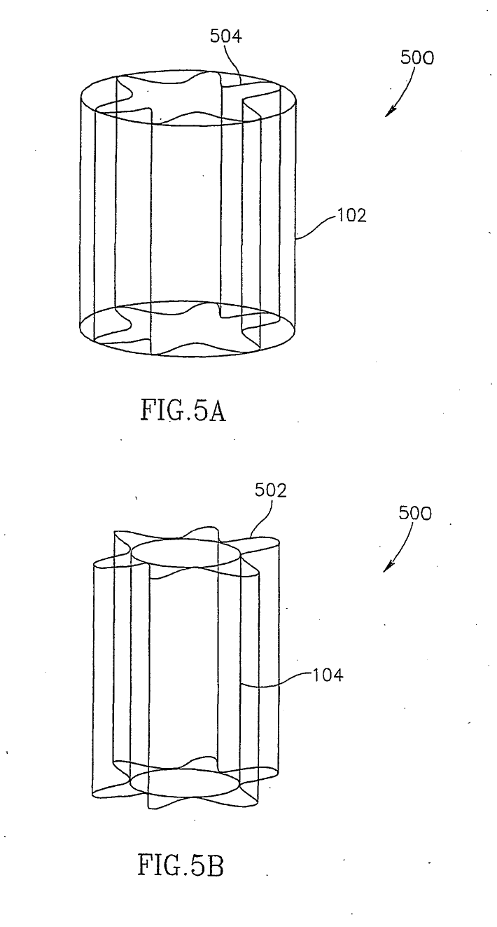

FIGS. 5A and 5B show a potentially even less expensive way to keep multiple discharges separated. In FIG. 5A, there is discharge tube 500 comprising a smooth sealed outer tube 102, as in FIG. 1, and an inner tube 504 which is rippled vertically, i.e. fluted. The number of ripples in tube 504 is equal to the number of electrodes at each end of the discharge tube, six in the case of the discharge tube shown in FIG. 5A. The electrodes at both the top and the bottom, which are arranged as in FIG. 1, are positioned so that the distance between the inner and outer tubes is greatest at the azimuthal position of the electrodes, and smallest at the azimuthal position half-way between two adjacent electrodes. The ripples optionally touch the inside of the outer tube, completely separating the multiple discharges which form between the top and bottom electrodes. Alternatively, the multiple discharges are not completely separated from each other, but the minimum distance between the inner and outer tube is small enough to prevent the multiple discharges from merging.

FIG. 5B shows a discharge tube 500 similar to that shown in FIG. 5A, but with a smooth inner tube 104, and a rippled outer tube 502. The ripples work in a similar way to the ripples in FIG. 5A. Having the ripples on the outside of the discharge tube instead of on the inside may improve heat transport. Customers may also have aesthetic preferences for having the ripples on the outside or the inside. Manufacturing a rippled tube may be less expensive than manufacturing six (or some other number) of separate tubes to hold separate discharges, particularly if there is no need for the rippled tube to fit very precisely against the other tube.

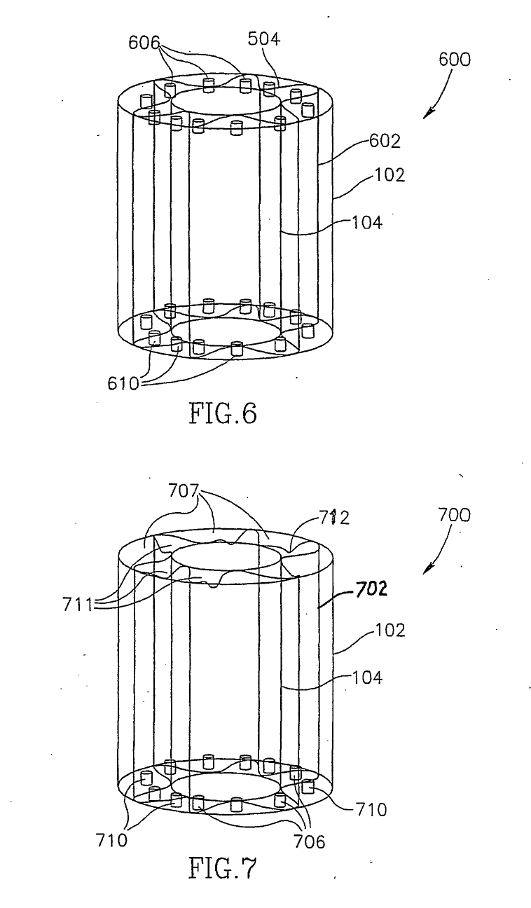

FIG. 6 shows a discharge tube 600 with a smooth outer tube 102, a smooth inner tube 104, both arranged as in FIG. 1, and a rippled intermediate tube 602. There are 12 electrodes 606 at the top of the discharge tube, and 12 electrodes 610 at the bottom of the discharge tube, with discharges going between corresponding electrodes. The 12 discharges fit into the six regions between the intermediate and outer tube, and the six regions between the intermediate and inner tube, made by the ripples. As in FIG. 5, the ripples may or may not seal off the regions completely. Discharge tube 600, with twice as many multiple discharges, makes more efficient use of the available space than discharge tube 500 in FIG. 5A or FIG. 5B, but may run at a hotter temperature if cooled only by free convection.

FIG. 7 shows a discharge tube 700 which is similar to discharge tube 600, with a smooth outer tube 102, a smooth inner tube 104, and a rippled intermediate tube 702. However, unlike in discharge tube 600, discharge tube 700 has only six pairs of electrodes, and all six pairs are located on the bottom of tube 700. Six inner electrodes 706 of one polarity are located in the six spaces 707 between the rippled intermediate tube and the inner tube, and six outer electrodes 710 are located in the six spaces 711 between the rippled intermediate tube and the outer tube. The ripples in intermediate tube 702 do not extend all the way to the bottom. Instead, there are openings 712 between each space 711, and the space 707 immediately to the right of it. Thus, preferably, each of the inner discharge paths is coupled to only one of the outer discharge paths. The openings between adjacent spaces may have any suitable shape. Each discharge flows from an outer electrode 710, up its corresponding space 711, through the opening 712 connecting that space 711 to the adjacent space 707, and down through space 707 to the corresponding inner electrode 706. As in FIGS. 5A, 5B, and 6, the ripples in discharge tube 700 may completely seal off spaces 707 and 711 from each other, or may only separate them enough to prevent the adjacent discharges from merging.

Many variations on discharge tube 700 will be apparent to someone skilled in the art, in light of the description of the other figures. For example, optionally the discharge tube is similar to discharge tube 500 in FIGS. 5A and 5B, without an intermediate tube, and the discharges go down the space created by one ripple, and up the space created by the adjacent ripple. If there are six ripples in the tube, then there would only be three pairs of electrodes.

Another option is to have a discharge go up and down the tube more than once, guided by alternate openings in the rippled tube at the top and bottom. Then there would be fewer electrodes for the same number of ripples. Optionally, there is only one pair of electrodes, and a single discharge which goes up one ripple and down the next ripple (with a configuration like any of FIGS. 5A, 5B, and 6), all around the discharge tube, ending close to where it started.

The construction of FIG. 4 can also be adapted for multiple serial longitudinal paths as described with respect to FIGS. 5-7.

The constructions of FIGS. 4-7 indicate that the barriers or ripples contact the adjacent tube. In an embodiment of the invention, the contacts form a seal. In an other embodiment of the invention, the barriers or ripples do not reach all the way to the adjacent tube. Rather a space is left between the adjacent paths delineated by the barriers or ripples. In some modes of operation, the barriers may be sufficient to keep the discharges' completely separate. In other embodiments, the discharges may merge, however, the barriers reduce any tendency for the discharges to join together over one or more limited segments of the periphery of the cylinders.

As indicated above, it is desirable that the discharges connected with the various pairs of electrodes do not coalesce at only a limited portion of the circumference of the cylinders. In an embodiment of the invention, metal or other conducting elements are situated either within or outside the envelope enclosing the discharges, along the path of the discharge. These elements can then assure that the discharge follows a desired path, be it a long path or around a bend as for example in the embodiment of FIGS. 2A and 2B. When the conducting elements are situated within the envelope, the discharge will preferentially travel between the elements. When the elements are outside the envelope, capacitance introduced by the elements can also guide the discharge. At the “turn-around” of the beam, the elements can guide the beams around the edge of element 110, so that the beams remain distinct. In some embodiments, the inner tube can be removed and only the elements used to guide the discharge.

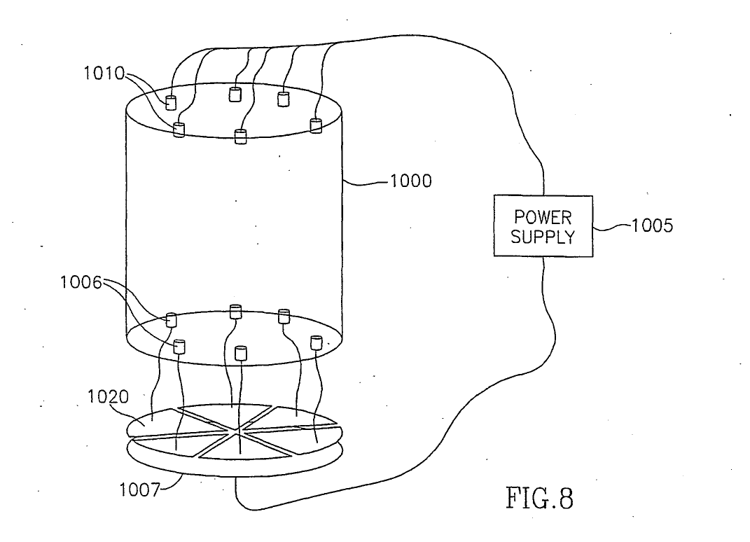

FIG. 8 illustrates another exemplary embodiment of the invention that may work best at high electrical frequencies. A discharge tube 1000 has six electrodes 1006 at the bottom and six electrodes 1010 at the top. Each electrode is connected to the power supply 1005 through a capacitor which limits its current, as is conventional with gas discharge tubes. In FIG. 10, the six capacitors are comprised by a single lower plate 1007, and an upper plate 1020 which is divided into six segments, each segment connected to one electrode. If the capacitive impedance is to be several thousand ohms, a typical value for the ballast in a fluorescent light fixture, then a single plate capacitor like that shown in FIG. 8 may only work at frequencies at least several kilohertz or tens of kilohertz. A capacitor system such as that shown is also generally connected to the electrodes on each side of the tube.

The tubes are, for example, produced of suitable transparent material for a desired light output. Optionally, the inner surface of the outermost tube is coated with a phosphor

The tubes are, for example, produced of suitable transparent material for a desired light output. Optionally, the inner surface of the outermost tube is coated with a phosphor material that converts light produced in the discharge to a desired wavelength or wavelengths of light. Optionally, the inner tube and/or any intermediate tube is also coated with a suitable phosphor.

In an embodiment of the invention, electronics, ballast and the like, for operating the discharge tube can be placed inside the inner tube. This allows for a compact system, in which a screw base, as in an ordinary incandescent lamp is mounted on one end of the device. Electricity is fed into the electronics from the screw base and distributed from the electronics to the various electrodes. The electrodes can be on one end of the device or on both ends, as shown in the various embodiments.

In some embodiments of the invention a reflecting member is placed inside the inner tube. This is especially useful when the electronics is placed in the center of the device, since otherwise, light output would be lost. Optionally, the electronics can be packaged in a reflecting tube or the like. Optionally, the reflecting material can be coated onto the axial facing surface of the inner tube. While under certain circumstances, the coating can be metallic (as for example, when the discharge is guided), in general, it is preferably to use a non-conducting coating such as a dielectric coating or a paint or a coating of a white material such as titanium dioxide.

While the invention is disclosed, for simplicity, with discharge paths that are generally in the direction of the axis of the device, it is possible, for example using variations of the embodiments of FIGS. 4-7 to provide guided paths that are at an angle to the length of the tube. Such paths will form a helix path or multiple helix paths about the central axis.

The present invention has been described with respect to a number of non-limiting embodiments thereof. It will be clear to a person of skill in the art that not all of the elements shown in a particular embodiment are absolutely necessary to the operation of that embodiment and that elements taken from different embodiments can be combined.

As used herein the terms “include,” comprises,” and “have” and their conjugates mean “including but not limited to.”

1. A gas discharge apparatus with a cylindrical axis, comprising:
a cylindrical outer tube, surrounding the axis;
a cylindrical inner tube surrounding the axis;
a plurality of pairs of electrodes situated between the inner and outer tubes; and
a gas contained between said inner tube and said outer tube, of suitable composition and pressure to create a gas discharge current when sufficient voltage is applied to said electrodes,
wherein no discharge is present inside the inner tube during operation.

2. A gas discharge apparatus according to claim 1, wherein discharge current flows substantially parallel to the axis along the length of the tubes.

3. A gas discharge apparatus according to claim 1, wherein the inside of inner tube is open to the outside environment.

4. A gas discharge apparatus according to claim 3, wherein the inside of inner tube is open to the outside environment at both ends thereof.

5. A gas discharge apparatus according to claim 1, and including:
a first end seal sealing between the inner and outer tubes at one end; and
a second end seal sealing between the inner and outer tubes at the other end,
wherein one electrode of each pair of electrodes is located adjacent to the first end, and the other electrode of each pair of electrodes is located adjacent to the second end.

6. A gas discharge apparatus according to claim 1, and including:
a first end seal sealing between the inner and outer tubes at one end;
an intermediate tube situated between the outer tube and the inner tube;
a second seal, sealing between the inner and outers tube at the other end, but not sealing the intermediate tube;
wherein one electrode of each pair of electrodes is located adjacent to the first end plate between the inner tube and the intermediate tube, and the other electrode of each pair of electrodes is located adjacent to the first end plate between the intermediate tube and the outer tube.

7. A gas discharge apparatus according to claim 1, and including bumps on a surface of a first one of the tubes, which surface faces a second one of the tubes, said bumps providing a fixed spacing between the tubes.

8. A gas discharge apparatus tube according to claim 7, wherein the bumps are sufficiently small and far apart that they do not significantly reduce the discharge current.

9. A gas discharge apparatus according to claim 1, and including at least one barrier located between two electrodes of different pairs, which barrier reduces the discharge current flowing between said electrodes of different pairs.

10. A gas discharge apparatus according to claim 9 wherein the barriers extend parallel to the discharge for a majority of the length of the discharge.

11. A gas discharge apparatus according to claim 9 wherein the barriers extend radially from one or both of the inner and outer tubes.

12. A gas discharge apparatus according to claim 11, wherein the barriers extend from one of the tubes and contact an adjacent tube.

13. A gas discharge apparatus according to claim 11, wherein the barriers extend only part of the distance between adjacent tubes.

14. A gas discharge apparatus according to claim 9 wherein the discharge is formed with a current in a first axial direction between two barriers and returns via a space between two adjacent baffles barriers.

15. A gas discharge apparatus according to claim 1 wherein the inner and outer cylindrical tubes have a circular cross-section.

16. A gas discharge apparatus according to claim 1 wherein at least one of the tubes does not have a circular cross-section.

17. A gas discharge apparatus according to claim 16 wherein the at least one tube having not having a circular cross section has a fluted cross-section.

18. A gas discharge apparatus according to claim 17 wherein the flutes contact at least one adjoining tube at the extremities of the flutes.

19. A gas discharge apparatus according to claim 18 wherein the contacts comprise a seal.

20. A gas discharge apparatus according to claim 17 wherein the flutes do not contact the adjoining tube at the extremities.

21. A gas discharge apparatus according to claim 1 wherein the flutes are formed in the inner tube.

22. A gas discharge apparatus according to claim 1 wherein the flutes are formed in the outer tube.

23. A gas discharge apparatus according to claim 1 wherein the flutes are formed in a tube intermediate the inner and outer tubes.

24. A gas discharge apparatus according to claim 1 wherein the discharge is formed with a current in a first axial direction between two flutes and returns via a space between two adjacent flutes.

25. A gas discharge apparatus according to claim 1 and including metallic elements placed along a desired path of the discharge.

26. A gas discharge apparatus according to claim 1 and including metallic elements placed outside the envelope of the discharge along and adjacent a desired path of the discharge.

27. A gas discharge apparatus according to claim 1 in which one or more surfaces of one or more tubes is coated with a phosphor that converts radiation produced by the discharge into light having a desired wavelength or wavelengths.

28. A gas discharge apparatus according to claim 1 and including electronics for energizing said discharge, situated axially of the inner tube.

29. A gas discharge apparatus according to claim 28 and including a screw socket at one end thereof supplying electrical power to said electronics.

30. A gas discharge apparatus according to any of the preceding claims wherein there are no barriers between discharges formed between different pairs of electrodes.

31. A gas discharge apparatus according to claim 1, and including separate ballast for each of the pairs of electrodes.
